(19) United States
(12) Patent Application Publication
(10) Pub. No.: US 2014/0196197 A1
(43) Pub. Date: Jul. 17, 2014

(54) CHEEK PAD WITH RECORDING FUNCTION

(71) Applicant: WUN-CHUAN WANG, Tainan City (TW)

(72) Inventor: CHIA HSING LIN, TAINAN CITY (TW)

(73) Assignee: WUN-CHUAN WANG, Tainan City (TW)

(21) Appl. No.: 14/148,937

(22) Filed: Jan. 7, 2014

(30) Foreign Application Priority Data
Jan. 11, 2013 (TW) 102101131

(51) Int. Cl. H04N 5/77; A42B 3/04; G11B 33/06; H04N 9/79; G11B 31/00

(52) U.S. Cl. CPC H04N 5/772; H04N 9/79; G11B 31/006; G11B 33/06; A42B 3/0406
USPC 2/410; 386/224

(57) ABSTRACT

The present disclosure provides a cheek pad with a recording function disposed on the inner sidewall of the helmet. The cheek pad with the recording function has a main body and a recording device. The main body has a flexible lining. The recording device is embedded into the flexible lining. The flexible lining exposes a lens of the recording device. The lens is movably adjusted, and the recording device is used to capture the ambient scene around the helmet.

### BACKGROUND

1. Technical Field

The present disclosure relates to a cheek pad, in particular, to a cheek pad with a recording function, which can be disposed in a helmet.

2. Description of Related Art

In the current life, following the promotion of the safety consciousness, the helmet becomes important. The helmet can protect the head of the person when the person drives the motorcycle, bicycle, or is located in the dangerous workplace.

However, the conventional helmet only has the function for protecting the head or neck of the person. When the person merely wears the conventional helmet, and a traffic accident or a collision accident happens, the scene of the traffic accident or the collision accident cannot be reproduced. Though the person can equip the recording device on the conventional helmet to reproduce the scene of the traffic accident or the collision accident, the safety structure of the conventional helmet may be destroyed, or the recording device may protrude from the conventional helmet to reduce the safety coefficient of the conventional helmet. Thus, when the recording device is broken to pieces due to the traffic accident or the collision accident, the broken pieces may hurt the person.

### SUMMARY

One objective of an exemplary embodiment of the present disclosure is to provide a cheek pad with a recording function to solve the aforementioned issues. The cheek pad with the recording function provided by the exemplary embodiment of the present disclosure has a recording device which can capture the ambient scene around the helmet. The cheek pad has a flexible lining, wherein a power device and the recording device are embedded into the flexible lining. Accordingly, the cheek pad with the recording function of the exemplary embodiment of the present disclosure can record the vehicle travelling video, and the cheek pad with the recording function can be installed in the helmet without affecting the safety of the helmet.

An exemplary embodiment of the present disclosure provides a cheek pad with a recording function, which is disposed on an inner sidewall of a helmet. The cheek pad with the recording function includes a main body and a recording device. The main body has a flexible lining. The recording device is embedded into the flexible lining, and the flexible lining exposes a lens of the recording device. The lens of the recording device lens is movably adjusted, and the recording device is capable of capturing an ambient scene around the helmet.

According to one exemplary embodiment of the present disclosure, the cheek pad further includes a power device embedded into the flexible lining. The power device is electrically connected to the recording device.

According to one exemplary embodiment of the present disclosure, the main body further includes a board and a connective structure. The board has a first hole thereon. A buckle belt of the helmet is capable of penetrating the first hole. The connective structure disposed on the board is capable of connecting with the helmet. The flexible lining is disposed on the board, and the board is disposed on the inner sidewall of the helmet through the connective structure.

According to one exemplary embodiment of the present disclosure, the main body further includes at least one adhesion layer, and the board further has at least one second hole thereon. The adhesion layer is disposed on the board.

According to one exemplary embodiment of the present disclosure, the flexible lining has a flexible cover portion used to cover the power device and the recording device. The flexible cover portion has a plurality of adhesion layers. One of the attaching layers of the flexible cover penetrates the second hole to stick with the at least one adhesion layer disposed on the board.

According to one exemplary embodiment of the present disclosure, the recording device further includes an external housing, a protective layer, a control unit, and an image sensing unit. The protective layer covers the external housing. The control unit is electrically connected to the image sensing unit, the image sensing unit is disposed corresponding to the lens, and control unit and the image sensing are disposed in the external housing. The external housing has an immovable portion and a rotating portion, and the rotating portion is pivotally connected to the immovable portion, such that the rotating portion rotates around the immovable portion. The lens is disposed in the rotating portion, and the rotating portion exposes the lens.

According to one exemplary embodiment of the present disclosure, the recording device further comprises an infrared ray emitter and a light emitting diode. The infrared ray emitter is disposed in the rotating portion, and electrically connected to the control unit. The light emitting diode is disposed in the rotating portion, and electrically connected to the control unit. The rotating portion exposes the infrared ray emitter and the light emitting diode.

According to one exemplary embodiment of the present disclosure, the control unit further includes a plurality of control switches. Some of the control switches are used to control the image sensing unit, such that the recording device is controlled to capture or stop capturing the ambient scene around the helmet. Some of the control switches are used to control the infrared ray emitter to light or stop lighting. The others of the control switches are used to control the light emitting diode to light or stop lighting.

According to one exemplary embodiment of the present disclosure, the flexible lining forms an inclined V-shaped structure or an inverted U-shaped structure. The flexible lining further includes a plurality of buffer portions, wherein one of the buffer portions is disposed between the power device and the recording device, and the others of the buffer portions covers power device and the recording device.

According to one exemplary embodiment of the present disclosure, the recording device further includes a sound receiver and a memory unit. The sound receiver is used to capture ambient sound around the helmet. The memory unit is used to record the ambient scene and the ambient sound around the helmet.

To sum up, the cheek pad with a recording function provided by the exemplary embodiment of the present disclosure is disposed on right inner sidewall or left inner sidewall of the helmet. The power device and the recording device are integrated into thin devices, and embedded into the flexible lining of the main body, wherein the buffer portions of the flexible lining cover the power device and the recording device. Thus, the cheek pad with the recording function can capture the ambient scene around the helmet, such as the vehicle traveling video, traffic accident video, or collision accident video. In addition, the cheek pad with the recording function can be installed in the helmet without affecting the safety of the helmet, and it is convenient for the user to adjust the lens of the recording device of the cheek pad with the recording device to make the recording device capture the ambient scene in which the user is interested.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1A shows an explosive diagram of a cheek pad with a recording function disposed on a helmet provided in accordance to an exemplary embodiment of the present disclosure.

FIG. 1B shows an assembling diagram of a cheek pad with a recording function disposed on a helmet provided in accordance to the exemplary embodiment of FIG. 1A.

FIG. 2A shows a front view diagram of a cheek pad with a recording function provided in accordance to the exemplary embodiment of FIG. 1B.

FIG. 2B shows a back view diagram of a cheek pad with a recording function provided in accordance to the exemplary embodiment of FIG. 2A.

FIG. 3A shows a front view diagram of a cheek pad with a recording function provided in accordance to another exemplary embodiment of the present disclosure.

FIG. 3B shows a back view diagram of a cheek pad with a recording function provided in accordance to the exemplary embodiment of FIG. 3A.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

### Exemplary Embodiment of Cheek Pad with Recording Function

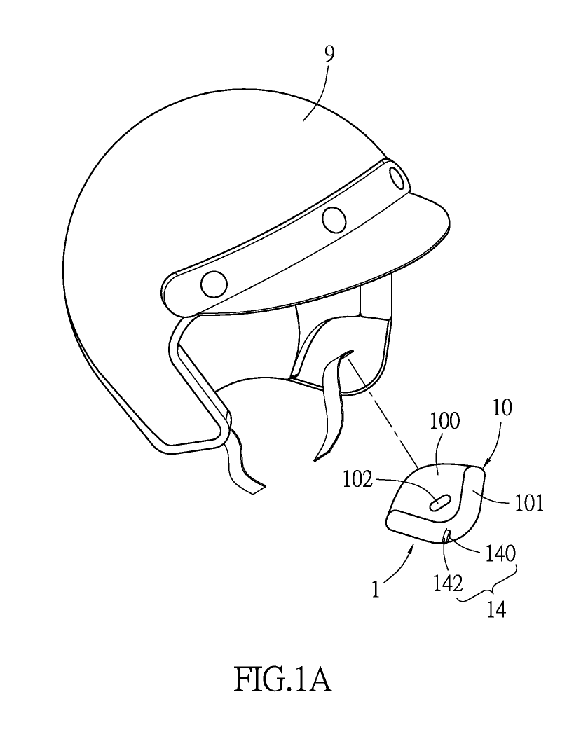

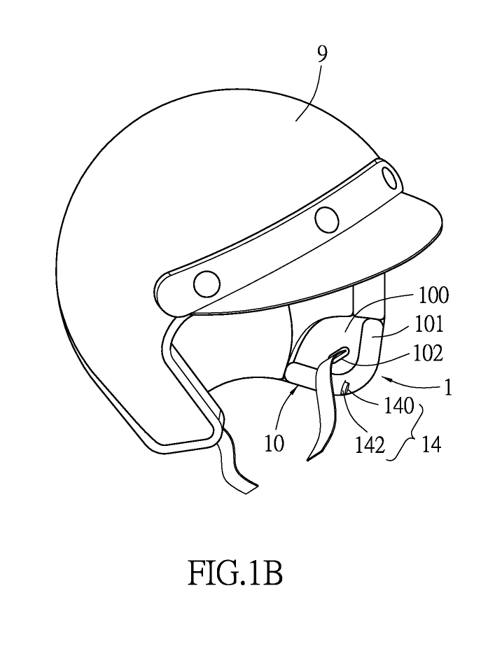

Please refer to FIG. 1A and FIG. 1B, FIG. 1A shows an explosive diagram of a cheek pad with a recording function disposed on a helmet provided in accordance to an exemplary embodiment of the present disclosure, and FIG. 1B shows an assembling diagram of a cheek pad with a recording function disposed on a helmet provided in accordance to the exemplary embodiment of FIG. 1A. As shown in FIG. 1A and FIG. 1B, the cheek pad 1 with the recording function is detachably disposed on left inner sidewall or right inner sidewall of the ¾ helmet (or called by open face helmet) 9. In general, the left inner sidewall or the right inner sidewall of the ¾ helmet 9 has a copper fastener, and thus the cheek pad 1 with the recording function can be directly fastened on the copper fastener. Accordingly, the user can install the cheek pad 1 with the recording function in the ¾ helmet 9 without destroy or modify the original rigid structure of the ¾ helmet 9, such that the rigidity of the ¾ helmet 9 remains intact. The cheek pad 1 with the recording function can capture ambient sound and ambient scene around the ¾ helmet 9. The present disclosure does not limit the type of the cheek pad 1 with the recording function, and does not limit the location which the cheek pad 1 with the recording function disposed on the ¾ helmet 9, either.

Specifically, the cheek pad 1 with the recording function includes a main body 10 and a recording device 14. The main body 10 has a flexible lining 101. The recording device 14 is embedded into the flexible lining 101. The flexible lining 101 exposes a lens 140 of the recording device 14. Accordingly, the lens 140 can be movably adjusted, and the recording device 14 can capture the ambient scene around the ¾ helmet 9 in which the user is interested.

For example, when a user wearing the ¾ helmet 9 drives the motorcycle or the bicycle and wears, and the cheek pad 1 with the recording function is disposed on the inner sidewall of the ¾ helmet 9, the cheek pad 1 with the recording function can capture the ambient scene and ambient sound around the ¾ helmet 9, and that is, the cheek pad 1 with the recording function acts as a vehicle traveling recorder. As shown in FIG. 1B, the cheek pad 1 with the recording function is disposed on the inner sidewall of the ¾ helmet 9, the lens 140 protrudes the flexible lining 101, and the user can adjust the view angle of the lens 140.

As shown in FIG. 1A, when the user reaches the destination, the user can remove the cheek pad 1 with the recording function from the ¾ helmet 9 to charge the cheek pad 1 with the recording function. When one of the inner elements of the cheek pad 1 with the recording function is damaged, the user can remove the cheek pad 1 with the recording function from the ¾ helmet 9 to repair the cheek pad 1 with the recording function. Certainly, it is convenient for the user to carry and store the cheek pad 1 with the recording function, to prevent the cheek pad 1 from being stolen or lost while the ¾ helmet 9 is stolen or lost.

It is noted that the lens 140 protrudes the flexible lining 101 and is not covered by the flexible lining 101. Thus, the junction between the lens 140 and the flexible lining 101 can be filled with the adhesive to cause the better cover effect.

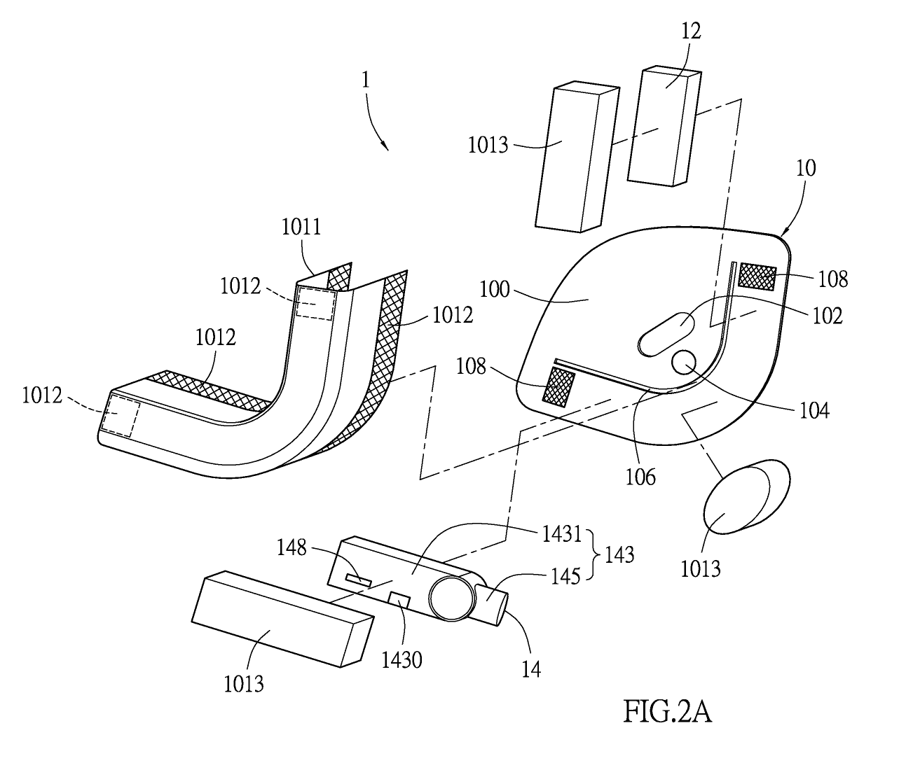

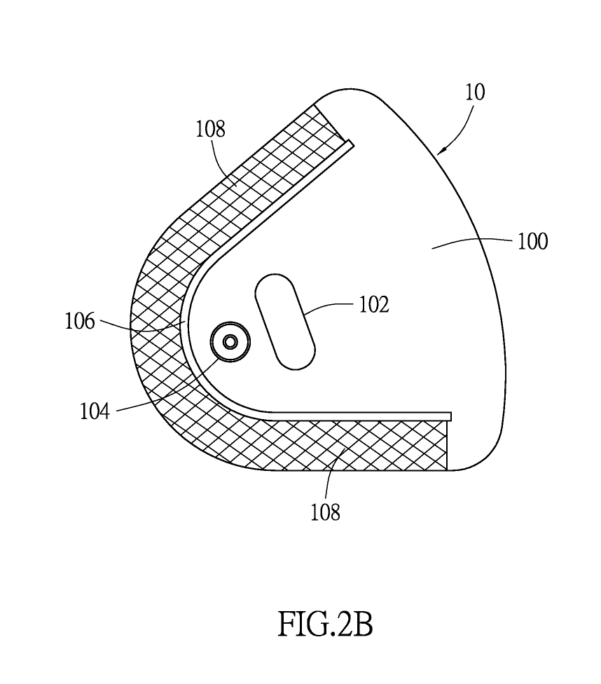

Next, the following description further elaborates the structure and the operation of the cheek pad 1 with the recording function. FIG. 2A shows a front view diagram of a cheek pad with the recording function provided in accordance to the exemplary embodiment of FIG. 1B. FIG. 2B shows a back view diagram of a cheek pad with a recording function provided in accordance to the exemplary embodiment of FIG. 2A. Please refer to FIG. 2A and FIG. 2B, the cheek pad 1 with the recording function is disposed on the inner sidewall of the ¾ helmet 9. The cheek pad 1 with the recording function includes a main body 10, a power device 12, and a recording device 14.

The main body 10 includes a board 100, a flexible lining 101, a connective structure 104, and at least one adhesion layer 108, wherein the board 100 has a first hole 102 and at least one second hole 106 thereon. In practice, the material of the board 100 can be plastic, metal, carbon fiber, or etc., and the present disclosure is not limited thereto. The board 100, for example, can be triangle, rectangle, polygon, or etc., and the present disclosure is not limited thereto.

The flexible lining 101 has a flexible cover portion 1011. In practice, the structure of the flexible cover portion 1011, for example, can be an inclined V-shaped structure, an inclined U-shaped structure, an irregular structure, or etc., and the present disclosure is not limited thereto. The flexible cover portion 1011 is used to cover the power device 12 and the recording device 14 on the main body 10. The material of the flexible cover portion 1011, for example, can be a leather, yarns, Cotton, nylon, or etc., and the present embodiment is not limited thereto. Besides, the flexible cover portion 1011 has a plurality of adhesion layers 1012. The adhesion layers 1012, for example, can be a Velcro, and the present embodiment is not limited thereto.

A buckle belt of the ¾ helmet 9 can penetrate the first hole 102 disposed on the board 100. In practice, the left and the right inner sidewalls of the general ¾ helmet 9 have the buckle belts. The first hole 102 is designed corresponding to the buckle belt, such that the buckle belt of the ¾ helmet 9 can penetrate the first hole 102. Accordingly, the user can wear the ¾ helmet 9 and fasten the two buckle belts of the ¾ helmet 9. Besides, the connective structure 104, for example, can be a copper fastener. The connective structure 104 disposed on the board 100 is used to connect with the cooper fastener of the inner sidewall of the ¾ helmet 9, such that the cheek pad 1 with the recording function can be disposed on the inner sidewall of the ¾ helmet 9 through the connective structure 104. The other elements in FIG. 2A and FIG. 2B are the same as those in the FIG. 1A and FIG. 1B, and further descriptions are hereby omitted.

The flexible cover portion 1011 can penetrate the second hole 106 on the board 100. In practice, the structure of the second hole 106, for example, can be an inclined V-shaped structure. The flexible cover portion 1011 can cover the power device 12 and the recording device 14 disposed on the front side of the board 100. One of the adhesion layers 1012 of the flexible cover portion 1011 penetrates the second hole 106 to contact the adhesion layer 108 of the back side of the board 100, such that the adhesion layer 1012 sticks with the adhesion layer 108 to achieve the effect for covering the power device 12 and the recording device 14.

More specifically, please refer to FIG. 2B, the adhesion layer 108 is disposed on the board 100 and is used to stick with the adhesion layer 1012 of the flexible cover portion 1011. In practice, the adhesion layer 108, for example, can be a Velcro. The number of the adhesion layer 108 can be one, two, or more, wherein some of the adhesion layers 108 are disposed on the front side of the board 100 to stick with the adhesion layer 1012 on the back side of the flexible cover portion 1011, as shown in FIG. 2A, and the others of the adhesion layers 108 are disposed on the back side of the board 100, as shown in FIG. 2B. Certainly, the present disclosure does not limit the number, type, and disposed position of the adhesion layer 108.

In another exemplary embodiment, the number of the second hole 106, for example, can be two, three, or more. The second hole 106 is formed corresponding to the positions which the power device 12 and the recording device 14 dispose on the front side of the board 100. Besides, the adhesion layer 1012 of the flexible cover portion 1011 is arranged related to the number and type of the second hole 106. Certainly, the present disclosure does not limit the type and number of the second hole 106.

As shown in FIG. 2A, the power device 12 is disposed on the main body 10. In practice, the power device 12, for example, can be a rechargeable battery, a lithium cell, a mercury battery, a nickel-metal hydride battery, solar cell, or etc., and the present disclosure does not limit the type of the power device 12. Certainly, the power device 12 can supply the power to the recording device 14 through a power line, wherein the power line is also covered by the flexible cover portion 1011.

It is worth to note that the flexible cover portion 1011 can be detachably removed. Thus, when one of the power device 12 and the recording device 14 is destroyed, the user can replace the destroyed one of the power device 12 and the recording device 14. In another embodiment, the power device 12 includes a charging structure, and thus the power device 12 can receive the power from the mobile power supply or the commercial electric main. The present disclosure does not limit the type of the power device 12.

The recording device 14 is disposed on the main body 10 and is electrically connected to the power 12. The recording device 14 includes a lens 140, an external housing 143, a protective layer 142, a control unit, an image sensing unit, and a memory unit. The image sensing unit, for example, can be a Complementary Metal-Oxide Semiconductor (CMOS) sensor or a Charge-Coupled Device (CCD). The external housing 143 exposes the lens 140, and the control unit and the image sensing unit are disposed in the external housing 143. The protective layer 142, for example, can be silica gel, rubber, plastic, or etc., and is used cover the lens 140, so as to protect the lens 140. Besides, when the accident happens, the probability which the shreds of broken lens 140 hurt the user is reduced, since the protective layer 142 covers the lens 140. Certainly, the present disclosure does not limit the type of the lens 140.

The control unit is disposed in the external housing 143, and is electrically connected to the power device 12 and the image sensing unit. In practice, the control unit, for example, can be a Central Processing Unit (CPU), microcontroller (MCU), or etc., thereby executing the operation and the process among the signals in the recording device 14. In practice, the control unit controls the image sensing unit to be enabled or disabled, such that the recording device 14 is controlled to capture or stop capturing the ambient scene around the ¾ helmet 9. The lens 140 is used to collect light of the ambient scene, and focus the collected light on the image sensing unit, and thus the image sensing unit generates an image corresponding to the current image of the ambient scene, and the control unit can control the memory unit to store the generated image. Besides, the control unit has a plurality of control switches, wherein some of the control switches are used to control the recording device 14 to capture or stop capturing the ambient image around the ¾ helmet 9. Certainly, the present does not limit the type of the control unit. It is noted that the memory unit can be an external or built-in storage device, and the external housing 143 has a slot 148 and at least one control button 1430 disposed on the immovable portion 1431 thereof, wherein the external storage device can be installed in recording device 14 through the slot 148, and the at least one control button 1430 is an human-machine interface allowing the user to control the control switches of the control unit.

The memory unit is electrically connected to the control unit and used to record the ambient scene around the helmet 9. The memory unit, for example, can be a flash memory, a secure digital (SD) card, an extreme digital-picture (XP) card, a memory stick (MS) card, a compact flash (CF), a multimedia compact (MMC) card, or etc., and the present disclosure does not limit the type of the memory unit. The type of the memory unit is not limited thereto in the present embodiment.

The external housing 143 has an immovable portion 1431 and a rotating portion 145, wherein the rotating portion 145 is pivotally connected to the immovable portion 1431. The lens 140 is disposed in the rotating portion 143, and the rotating portion 145 exposes the lens. The control unit and the image sensing unit can be disposed in the external housing 143, in particularly, in the immovable portion 1431. The rotating portion 145 can be rotated around the immovable portion 1431, thus the lens 140 can also rotate, and the recording device 14 can capture the ambient scene around the ¾ helmet 9 which the user is interested. The rotating portion 145 can be rotated mutually; or alternatively, the rotating portion 145 can has an actuator electrically connected to the control unit, such that the control unit can control the rotation of the rotating portion 145. Certainly, the present disclosure does not limit the type of the rotating portion 145 and the pivotal connection manner.

It is worth to note that the flexible lining 101 further includes a plurality of buffer portions 1013. The buffer portions 1013, for example, can be high-density sponge, foam, latex, silica gel, rubber, or etc., and the present disclosure does not limit the material of the buffer portions 1013. One of the buffer portions 1013 is disposed between the power device 12 and the recording device 14, such that the flexible lining 101 forms an inclined V-shaped structure or an inverted U-shaped structure. The others of the buffer portions 1013 are disposed between the flexible cover portion 1011 and the main body 10 to cover the power device 12 and the recording device 14. The present disclosure the type and the disposed position of the buffer portions 1013.

Regarding the cheek pad 1 with the recording function, the power device 12 and the recording device 14 can be integrated into the thin devices, and the power device 12 and the recording device 14 are disposed on the main body 10. For example, the thickness of the power device 12 or the recording device 14 may be decreased to be about 8 mm, and the buffer portions 1013 made of high-density sponge, foam, latex, silica gel, rubber, or etc., cover the power device 12 and the recording device 14, such that the volume of the cheek pad 1 with the recording function is same as that of the cheek pad of the conventional ¾ helmet. Moreover, the cheek pad 1 with the recording function can be installed in the ¾ helmet 9 without affecting the safety of the ¾ helmet 9, and furthermore, it is convenient to the user for rotating the lens 140, such that the user can use the cheek pad 1 with the recording function to capture the ambient scene around the ¾ helmet 9 in which the user is interested.

### Another Exemplary Embodiment of Cheek Pad with Recording Function

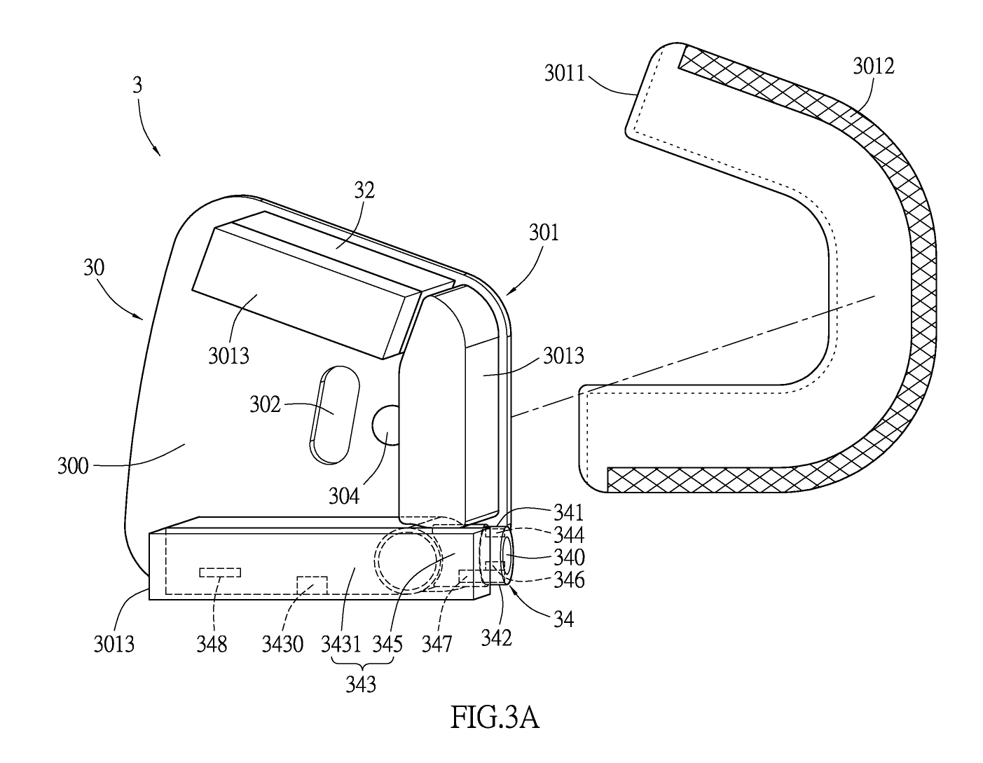

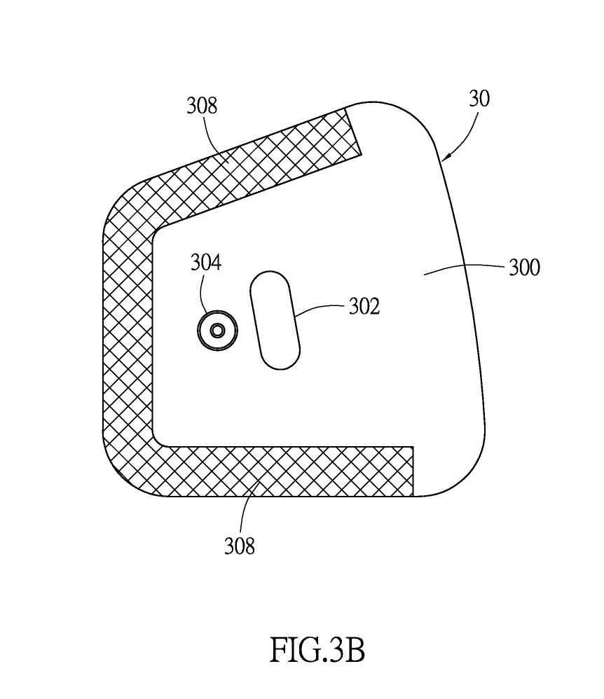

Please refer to FIG. 3A and FIG. 3B. FIG. 3A shows a front view diagram of a cheek pad with a recording function provided in accordance to another exemplary embodiment of the present disclosure. FIG. 3B shows a back view diagram of a cheek pad with a recording function provided in accordance to the exemplary embodiment of FIG. 3A. The cheek pad 3 with the recording function provided by the exemplary embodiment of the present embodiment is similar to the cheek pad 1 with the recording function provided by the aforementioned exemplary embodiment, such as the cheek pad 3 with the recording function can also capture the ambient scene around the helmet. Comparing to the cheek pad 1 with the recording function, the recording device 34 of the cheek pad 3 with the recording function further comprises an infrared ray emitter 344, a sound receiver 347, and a light emitting diode 346. The lens 340, the infrared ray emitter 344, and the LED 346 are disposed in the rotating portion 345 of the external housing 341, and the rotating portion 345 exposes the lens, the infrared ray emitter 344, and the LED 346. The infrared ray emitter 344 provides an infrared ray to illuminate a target in the ambient scene. The LED 346 is used for illumination. The sound receiver 347 is used to capture the ambient sound around the helmet. In practice, the sound receiver 347, for example, can be a microphone, and the present disclosure does not limit the type and disposed location of the sound receiver 347.

Next, the protective layer 342 covers the external housing 341, the lens 340, the infrared ray emitter 344, and the LED 346, such that the protective layer 342 can reduce the probability which the shreds of the lens 340, the infrared ray emitter 344, and the LED 346 hurt the head of the user. Certainly, the present disclosure does not limit the type of the recording device 34.

Certainly, the control unit can further control the infrared ray emitter 344 and the LED 346. For example, the control unit can include a plurality of control switches. Some of control switches are used to control the infrared ray emitter 344 to light or stop lighting. The others of the control switches are used to control the LED 346 to light or stop lighting. However, the present disclosure does not limit the type of the control unit.

It is worth to note that the flexible cover portion 3011 has only an adhesion layer 3012. The adhesion layer 3011 is sewed on the back side of the board 300 corresponding to the adhesion layer 3012 on front side of the flexible cover portion 3011. Thus, the adhesion layer 3012 can stick with the adhesion layer 308 on the back side of the board 300 to achieve the effect for covering the power device 32 and the recording device 34.

Furthermore, the board 300 of the main body 30 is trapezoid. The connective structure 34 can be removed, and the cheek pad 3 with the recording function can be directly pasted on the left inner sidewall or the right inner sidewall of the helmet, and the present disclosure does not limit the type of the main body. The buffer portions 3013, the switch button 3430, the flexible lining 301, the first hole 302, the immovable portion 3431, the slot 348, and the image sensing unit are respectively the same as buffer portions 1013, the switch button 1430, the flexible lining 101, the first hole 102, the immovable portion 1431, the slot 148, and the image sensing unit of FIG. 2A and FIG. 2B.

Those skilled in the art shall know the operation of the exemplary embodiment of FIG. 3A and FIG. 3B is substantially equivalent to the exemplary embodiment of FIG. 1A through FIG. 1B. The person with ordinary skill in the art should be able to deduce the operating of the exemplary embodiment of FIG. 3A and FIG. 3B after referring the details of the exemplary embodiment of FIG. 1A through FIG. 1B, and thus the redundant description is omitted.

In summary, the cheek pad with the recording function provided by the exemplary embodiment of the present disclosure is disposed on the inner sidewall of the helmet, and used to capture an ambient scene, so as to record the vehicle traveling video, the traffic accident video, or the collision accident video. The power device and the recording device can be integrated into thin devices, and the power device and the recording device are embedded into the flexible lining of the main body. The thickness of the power device and the recording device can be decreased to about 8 mm. The cheek pad with the recording function can be installed in the helmet without affecting the safety of the helmet, and furthermore, it is convenient to the user for rotating the lens, such that the user can use the cheek pad with the recording function to capture the ambient scene around the helmet in which the user is interested. Furthermore, when the accident happens, the probability which the shreds of broken lens hurt the user is reduced, since the protective layer covers the lens.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A cheek pad with a recording function, disposed on an inner sidewall of a helmet, comprising:
a main body, having a flexible lining; and
a recording device, embedded into the flexible lining, wherein the flexible lining exposes a lens of the recording device;
wherein the lens is movably adjusted, and the recording device is used to capture an ambient scene around the helmet.

2. The cheek pad with the recording function according to claim 1, further comprising a power device embedded into the flexible lining and electrically connected to the recording device.

3. The cheek pad with the recording function according to claim 2, wherein the main body further comprises:
a board, having a first hole thereon, wherein a buckle of the helmet penetrates the first hole;
a connective structure, disposed on the board, used to connect with the helmet;
wherein the flexible lining is disposed on the board, and the board is disposed on the inner sidewall of the helmet through the connective structure.

4. The cheek pad with the recording function according to claim 3, wherein the board further comprises at least one second hole and at least one adhesion layer thereon.

5. The cheek pad with the recording function according to claim 4, wherein the flexible lining has a flexible cover portion used to cover the power device and the recording device, the flexible cover portion has a plurality of adhesion layers, one of the adhesion layers penetrates the second hole to stick with the adhesion layer of the board.

6. The cheek pad with the recording function according to claim 1, wherein the recording device further comprises:
an external housing, having an immovable portion and a rotating portion, wherein the immovable portion is pivotally connected to the immovable portion;
a protective layer, covering the external housing;
a control unit; and
an image sensing unit;
wherein the control unit is electrically connected to the image sensing unit, the image sensing unit is disposed corresponding to the lens, and the control unit and the image sensing unit are disposed in the external housing; the rotating portion is pivotally connected to the immovable portion, such that the rotating portion rotates around the immovable portion; and the lens is disposed in the rotating portion, and the rotating portion exposes the lens.

7. The cheek pad with the recording function according to claim 6, wherein the recording device further comprises:
an infrared ray emitter; and
a light emitting diode;
wherein the infrared ray emitter is disposed in the rotating portion, and electrically connected to the control unit; the light emitting diode is disposed in the rotating portion, and electrically connected to the control unit; the rotating portion exposes the infrared ray emitter and the light emitting diode.

8. The cheek pad with the recording function according to claim 7, wherein the control unit further comprises:
a plurality of control switches, wherein some of the control switches are used to control the image sensing unit, such that the recording device is controlled to capture or stop capturing the ambient scene around the helmet, some of the control switches are used to control the infrared ray emitter to light or stop lighting, and the others of the control switches are used to control the light emitting diode to light or stop lighting.

9. The cheek pad with the recording function according to claim 2, wherein the flexible lining forms an inclined V-shaped structure or an inverted U-shaped structure, the flexible lining further comprises a plurality of buffer portions, wherein one of the buffer portions is disposed between the power device and the recording device, and the others of the buffer portions covers the power device and the recording device.

10. The cheek pad with the recording function according to claim 1, wherein the recording device further comprises a sound receiver and a memory unit, the sound receiver is used to capture an ambient sound around the helmet, and the memory unit is used to record the ambient scene and the ambient sound around the helmet.
